(19) United States
(12) Patent Application Publication
(10) Pub. No.: US 2023/0075729 A1
(43) Pub. Date: Mar. 9, 2023

(54) SLOTTER HEAD, SLOTTER DEVICE AND BOX MAKING MACHINE

(71) Applicant: MITSUBISHI HEAVY INDUSTRIES MACHINERY SYSTEMS, LTD., Hyogo (JP)

(72) Inventors: Mitsuhiro NADACHI, Hyogo (JP); Yasunari SUZUKI, Hyogo (JP); Masayoshi TANCHI, Hyogo (JP); Kazushige KUROKAWA, Hyogo (JP); Masaya FUJINO, Hyogo (JP); Makoto SHIMOHATSUBO, Hyogo (JP)

(21) Appl. No.: 17/795,944

(22) PCT Filed: Jan. 20, 2021
(86) PCT No.: PCT/JP2021/001810

§ 371 Date: Jul. 28, 2022

(30) Foreign Application Priority Data
Jan. 31, 2020 (JP) 2020-014668

(51) Int. Cl. B26D 1/28; B31B 50/04; B31B 50/22; B31B 50/25; B31B 50/26; B31B 50/60; B31B 50/88

(52) U.S. Cl. CPC B26D 1/285; B31B 50/04; B31B 50/22; B31B 50/25; B31B 50/26; B31B 50/60; B31B 50/88

(57) ABSTRACT

Provided are a slotter head, a slotter device and a box making machine comprising a cutter holder which is in a disk shape and is rotationally supported, a first cutting blade which is mounted to an outer peripheral portion of the cutter holder, a moving holder which is supported by the cutter holder movably along the circumferential direction, a second cutting blade which is mounted to an outer peripheral portion of the moving holder, a first drive device which rotationally drives the cutter holder, and a second drive device which rotationally drives the moving holder.

### TECHNICAL FIELD

The present disclosure relates to a slotter head that performs a groove cutting process in a sheet material such as a corrugated cardboard box, a slotter device including the slotter head, and a box making machine including the slotter device.

### BACKGROUND ART

A box making machine manufactures a box body (corrugated box) by processing a sheet material (for example, a corrugated cardboard box). The box making machine is configured of a sheet feeding section, a printing section, a slotter creaser section, a die cutting section, a folding section, a counter-ejector section, and the like. The sheet feeding section sends out the corrugated cardboard boxs stacked on a table one by one and sends them to the printing section at a constant speed. The printing section has a plurality of printing units and performs printing on the corrugated cardboard box. The slotter creaser section forms a creasing line to be a folding line on the corrugated cardboard box, and performs processes of a groove forming a flap and a gluing margin strip for joining. The die cutting section performs a punching process of a hand hole or the like on the corrugated cardboard box. The folding section applies glue to the gluing margin strip of the corrugated cardboard box, folds the corrugated cardboard box along the creasing line, and joins the gluing margin strips to manufacture a flat corrugated box. The counter-ejector section stacks corrugated boxes, sorts them into a predetermined number of batches, and discharges them.

In such a box making machine, the slotter creaser section has a slotter device that performs a grooving process for forming a flap. The slotter device is configured of an upper slotter head and a lower slotter head. The upper slotter head has a blade fixed to an outer peripheral portion, and the lower slotter head is provided with a circumferential groove in which the blade fits into the outer peripheral portion. Therefore, when a sheet material is transferred between the upper slotter head and the lower slotter head that rotate relative to each other, a groove is formed in the sheet material when the blade of the upper slotter head is fitted into a circumferential groove of the lower slotter head.

The box making machine manufactures a box body by processing sheet materials of a plurality of different sizes. The sheet materials of different sizes have different groove portion positions in a transfer direction. The blade is movably mounted on the outer peripheral portion of the upper slotter head, and it is necessary to adjust the position of the blade in the upper slotter head in the circumferential direction according to the position of the groove portion in the sheet material. As such a slotter device, for example, there is one described in the following Patent Literature 1.

### Citation List

### Patent Literature

[PTL 1] Japanese Unexamined Utility Model Registration Application Publication No. 60-67118

### SUMMARY OF INVENTION

### Technical Problem

The upper slotter head has a disk-shaped fixed slotter knife base, a first cutting blade is fixed to the fixed slotter knife base, and a second cutting blade is movably mounted on the fixed slotter knife base in the circumferential direction. In the conventional slotter device, the fixed slotter knife base can be rotated by a first motor, and the second cutting blade can be moved in the circumferential direction by a second motor to adjust a relative position with the first cutting blade. Then, when the grooving process is performed on the sheet by the upper slotter head, the fixed slotter knife base is rotated by the first motor. At this time, it is necessary to maintain the relative positions of the first cutting blade and the second cutting blade. Therefore, when the first motor rotates the first cutting blade via the fixed slotter knife base, the position of the second cutting blade is adjusted by the second motor so that the relative positions of the first cutting blade and the second cutting blade do not change. Therefore, a gear mechanism for controlling the relative positions of the first cutting blade and the second cutting blade is required, which causes a problem that the device becomes complicated.

The present disclosure is provided to solve the above-mentioned problems, and an object of the present disclosure is to provide a slotter head, a slotter device, and a box making machine for simplifying the device.

### Solution to Problem

A slotter head of the present disclosure for achieving the above object includes a fixed slotter knife base that has a disk shape and is rotatably supported; a first cutting blade that is mounted on an outer peripheral portion of the fixed slotter knife base; a moving slotter knife base that is movably supported by the fixed slotter knife base in a circumferential direction; a second cutting blade that is mounted on an outer peripheral portion of the moving slotter knife base; a first drive device that rotationally drives the fixed slotter knife base; and a second drive device that rotationally drives the moving slotter knife base.

Further, a slotter device of the present disclosure includes an upper rotary shaft and a lower rotary shaft that are rotatably supported; and an upper slotter head and a lower slotter head that are fixed to the upper rotary shaft and the lower rotary shaft, respectively to perform a groove cutting process of a sheet, in which the slotter head is applied as the upper slotter head.

Further, a box making machine of the present disclosure includes a sheet feeding section that supplies a sheet; a printing section that performs printing on the sheet; a slotter creaser section that has the slotter device which performs a creasing line process and a groove cutting process on a surface of the sheet; a folding section that forms a box body by folding the sheet and joining end portions; and a counter-ejector section that discharges every predetermined number of the box bodies after stacking the box bodies while counting the box bodies.

### Advantageous Effects of Invention

According to the slotter head, the slotter device, and the box making machine of the present disclosure, the device can be simplified.

### BRIEF DESCRIPTION OF DRAWINGS

FIG. 1 is a schematic configuration view showing a box making machine of the present embodiment.

FIG. 2 is a plan view of a corrugated cardboard box processed at a slotter creaser section.

FIG. 3 is a schematic side view showing a slotter device of the present embodiment.

FIG. 4 is a schematic front view showing the slotter device.

FIG. 5 is a front view of a slotter head of the present embodiment.

FIG. 6 is a sectional view showing a cross section of the slotter head taken along line VI-VI of FIG. 5.

FIG. 7 is a sectional view showing a cross section of a slotter head of a modified example.

FIG. 8 is a graph showing rotation control of a slotter knife at the time of starting the slotter device.

FIG. 9 is a graph showing rotation control of the slotter knife when the slotter device is operated.

FIG. 10 is a graph showing rotation control of the slotter knife when the slotter device is stopped.

FIG. 11 is a schematic view showing a first stop state of the slotter device.

FIG. 12 is a schematic view showing a second stop state of the slotter device.

FIG. 13 is a schematic view showing a third stop state of the slotter device.

### DESCRIPTION OF EMBODIMENTS

Preferred embodiments of the present disclosure will be described in detail below with reference to the drawings. It should be noted that the present disclosure is not limited to the embodiment, and when there are a plurality of embodiments, the present embodiment also includes a combination of the respective embodiments. Further, the configuration elements in the embodiment include those that can be easily assumed by those skilled in the art, those that are substantially the same, that are, those in a so-called equal range.

### Configuration of Box Making Machine

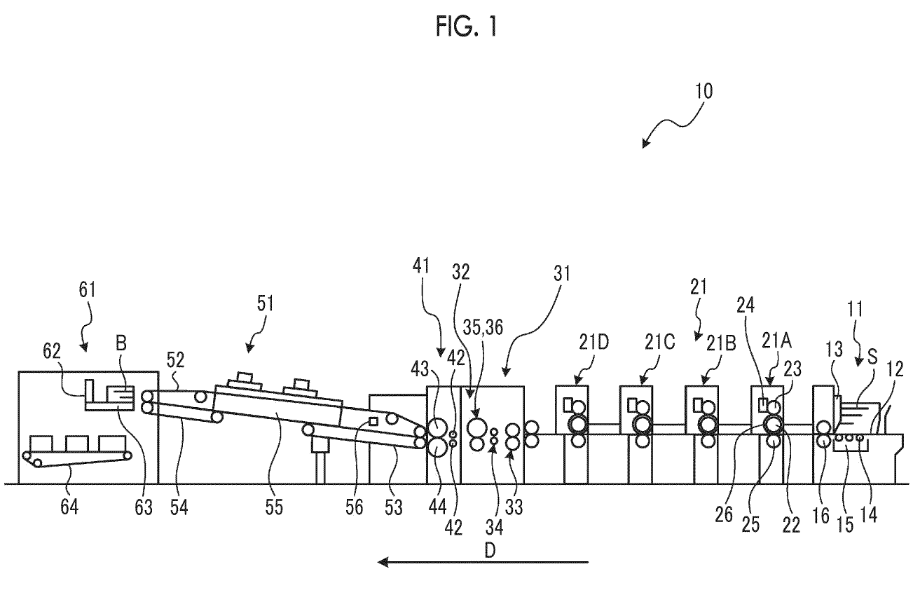

FIG. 1 is a schematic configuration view showing a box making machine of the present embodiment.

In the present embodiment, as shown in FIG. 1, a box making machine 10 manufactures a corrugated box (box body) B by processing a corrugated cardboard box S. The box making machine 10 includes a sheet feeding section 11, a printing section 21, a slotter creaser section 31, a die cutting section 41, a folding section 51, and a counter-ejector section 61. The sheet feeding section 11, the printing section 21, the slotter creaser section 31, the die cutting section 41, the folding section 51, and the counter-ejector section 61 are disposed in a straight line along a direction D in which the corrugated cardboard box S and the corrugated box B are transferred.

The sheet feeding section 11 sends out the corrugated cardboard boxs S one by one and sends them to the printing section 21 at a constant speed. The sheet feeding section 11 includes a table 12, a front pad 13, a supply roller 14, a suction device 15, and a feed roll 16. The table 12 can be placed by stacking a large number of corrugated cardboard boxs S, and is supported so as to be able to move up and down. The front pad 13 can position a front end position of the corrugated cardboard boxs S stacked on the table 12, and a gap through which one corrugated cardboard box S can pass is secured between a lower end portion and the table 12. A plurality of supply rollers 14 are disposed in the transfer direction D of the corrugated cardboard box S corresponding to the table 12, and when the table 12 is lowered, and send the table 12 at the lowest position among a large number of stacked corrugated cardboard boxs S forward. The suction device 15 sucks the stacked corrugated cardboard boxs S downward, that is, toward the table 12 and the supply roller 14. The feed roll 16 supplies the corrugated cardboard box S sent out by the supply roller 14 to the printing section 21.

The printing section 21 performs multicolor printing (four-color printing in the present embodiment) on the surface of the corrugated cardboard box S. In the printing section 21, four printing units 21A, 21B, 21C, and 21D are disposed in series, and printing is performed by using the four ink colors on the surface of the corrugated cardboard box S. Each of the printing units 21A, 21B, 21C, and 21D is configured in substantially the same manner, and has a printing cylinder 22, an ink supply roll (anilox roll) 23, an ink chamber 24, and a receiving roll 25. A printing plate 26 is attached to an outer peripheral portion of the printing cylinder 22, and the printing cylinder 22 is rotatably provided. The ink supply roll 23 is disposed so as to be in contact with the printing plate 26 in the vicinity of the printing cylinder 22 and is rotatably provided. The ink chamber 24 stores ink and is provided in the vicinity of the ink supply roll 23. By sandwiching the corrugated cardboard box S with the printing cylinder 22, the receiving roll 25 is transferred while applying a predetermined printing pressure, and is rotatably provided facing the lower side of the printing cylinder 22. Although not shown, each of the printing units 21A, 21B, 21C, and 21D is provided with a pair of upper and lower feed rolls before and after the printing units 21A, 21B, 21C, and 21D.

The slotter creaser section 31 is subjected to a creasing line process and a groove cutting process on the corrugated cardboard box S. The slotter creaser section 31 has a slotter device 32. The slotter device 32 performs groove cutting process on the corrugated cardboard box S. The slotter creaser section 31 has a first creasing roll 33, a second creasing roll 34, a slitter head 35, and a slotter head 36.

A plurality of (four in the present embodiment) of the first creasing rolls 33 are disposed at predetermined intervals in the horizontal direction orthogonal to the transfer direction D of the corrugated cardboard box S, and can be rotated by a drive device (not shown). A plurality of second creasing rolls 34 (4 in the present embodiment) are disposed at predetermined intervals in the horizontal direction orthogonal to the transfer direction D of the corrugated cardboard box S, and can be rotated by a drive device (not shown). In the first creasing roll 33 and the second creasing roll 34, a back surface (lower surface) of the corrugated cardboard box S is subjected to the creasing line process.

A plurality (five in total in the present embodiment) of slitter heads 35 and slotter heads 36 are disposed at predetermined intervals in the horizontal direction orthogonal to the transfer direction D of the corrugated cardboard box S, and can be rotated by a drive device (not shown). The slitter head 35 is configured of one piece and is provided corresponding to an end portion in a width direction of the corrugated cardboard box S to be transferred, and cuts the end portion in the width direction of the corrugated cardboard box S. The slotter head 36 is configured of four pieces, is provided corresponding to a predetermined position in the width direction of the corrugated cardboard box S to be transferred, performs the groove cutting process at a predetermined position in the corrugated cardboard box S, and performs the gluing margin strip process.

The die cutting section 41 performs a punching process such as a hand hole on the corrugated cardboard box S. The die cutting section 41 has a pair of upper and lower feed pieces 42, an anvil cylinder 43, and a head cylinder 44. The feed pieces 42 sandwiches and transfers the corrugated cardboard box S from above and below, and are rotatably provided. The anvil cylinder 43 and the head cylinder 44 are each formed in a circular shape, and can be synchronously rotated by a drive device (not shown). In this case, the anvil cylinder 43 has an anvil formed on an outer peripheral portion, while the head cylinder 44 has a head and a die formed at predetermined positions on an outer peripheral portion.

The folding section 51 folds the corrugated cardboard box S in the transfer direction D while being moved, and joins both end portions thereof in the width direction to form a flat corrugated box B. The folding section 51 includes an upper transfer belt 52, lower transfer belts 53 and 54, and a forming device 55. The upper transfer belt 52 and the lower transfer belts 53 and 54 sandwich and transfer the corrugated cardboard box S and the corrugated box B from above and below. The forming device 55 has a pair of left and right forming belts, and the corrugated cardboard box S is folded while bending each end portion in the width direction downward by the forming belt. Further, the folding section 51 is provided with a gluing device 56. The gluing device 56 has a glue gun and discharges glue at a predetermined timing to glue a predetermined position on the corrugated cardboard box S.

The counter-ejector section 61 stacks the corrugated boxes B while counting them, sorts them into a predetermined number of batches, and then discharges them. The counter-ejector section 61 has a hopper device 62. The hopper device 62 has an elevator 63 that can be lifted and lowered, on which corrugated boxes B are stacked, and the elevator 63 is provided with a front plate and a square plate (not shown) as shaping means. A carry-out conveyor 64 is provided below the hopper device 62.

### Corrugated Cardboard Box

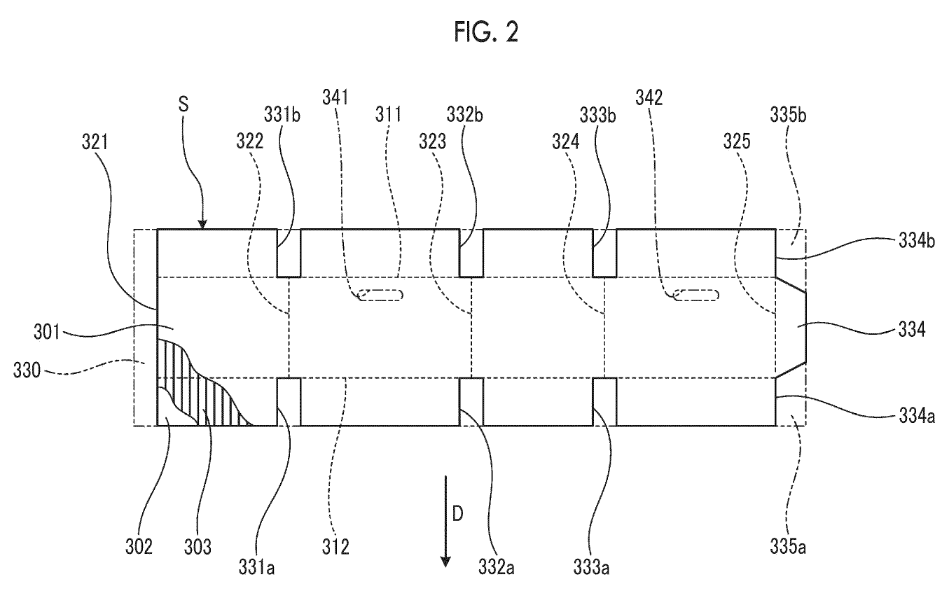

FIG. 2 is a plan view of the corrugated cardboard box processed by the slotter creaser section.

As shown in FIG. 2, the corrugated cardboard box S is formed by gluing a waved medium 303 between a bottom liner 301 and a top liner 302. In the corrugated cardboard box S, two folding lines 311 and 312 are formed in advance in the pre-process of the box making machine 10. The folding lines 311 and 312 are for folding the flaps when the corrugated box B manufactured by the box making machine 10 is assembled later.

The corrugated cardboard box S is subjected to the creasing line process and the groove cutting process in the slotter creaser section 31. In the corrugated cardboard box S, cutting lines 321 and creasing lines 322, 323, 324, and 325 are formed at predetermined intervals in the width direction. Further, in the corrugated cardboard box S, grooves 331a, 331b, 332a, 332b, 333a, and 333b, and notches 334a and 334b are formed at predetermined intervals in the width direction.

### Action of Box Making Machine

As shown in FIG. 1, a large number of corrugated cardboard boxs S are stacked on the table 12 of the sheet feeding section 11. In the sheet feeding section 11, the corrugated cardboard box S is positioned by the front pad 13, and the table 12 is lowered to send out the corrugated cardboard box S at the lowest position by a plurality of supply rollers 14. Then, the corrugated cardboard box S is supplied to the printing section 21 at a predetermined constant speed by a pair of feed rolls 16.

In the printing section 21, each of the printing units 21A, 21B, 21C, and 21D is supplied with ink from the ink chamber 24 on the surface of the ink supply roll 23, and when the printing cylinder 22 and the ink supply roll 23 rotate, the ink on the surface of the ink supply roll 23 is transited to the printing plate 26. When the corrugated cardboard box S is transferred between the printing cylinder 22 and the receiving roll 25, the corrugated cardboard box S is sandwiched between the printing plate 26 and the receiving roll 25, and printing pressure is applied to the corrugated cardboard box S to print on the surface. The printed corrugated cardboard box S is transferred to the slotter creaser section 31 by the feed roll.

As shown in FIGS. 1 and 2, when the corrugated cardboard box S passes through the first creasing roll 33 in the slotter creaser section 31, the creasing lines 322, 323, 324, and 325 are formed on the back surface side of the corrugated cardboard box S, that is, on the top liner 302. When the corrugated cardboard box S passes through the second creasing roll 34, similarly to the first creasing roll 33, the creasing lines 322, 323, 324, and 325 are reformed on the back surface side of the corrugated cardboard box S, that is, on the top liner 302.

Next, when the corrugated cardboard box S on which the creasing lines 322, 323, 324, and 325 are formed passes through the slitter head 35, one end portion 330 is cut by the cutting line 321. Further, when the corrugated cardboard box S passes through each slotter head 36, the grooves 331a, 332a, and 333a, and the notch 334a are formed at positions on a downstream side of the creasing lines 322, 323, and 324, and the grooves 331b, 332b, and 333b, and the notch 334b are formed at positions on an upstream side of the creasing line 322, 323, and 324. The other end portions 335a and 335b are cut by the notches 334a and 334b to form the gluing margin strip (joint piece) 334. After that, the corrugated cardboard box S that has been subjected to the creasing line process and the groove cutting process is transferred to the die cutting section 41.

In the die cutting section 41, when the corrugated cardboard box S passes between the anvil cylinder 43 and the head cylinder 44, hand holes 341 and 342 are formed. The corrugated cardboard box S in which the hand holes 341 and 342 are formed is transferred to the folding section 51.

In the folding section 51, the corrugated cardboard box S is moved in the transfer direction D by the upper transfer belt 52 and the lower transfer belts 53 and 54. The gluing device 56 applies glue to the gluing margin strip 334, and the forming device 55 folds the corrugated cardboard box S downward with the creasing lines 322 and 324 as the base points. When the folding progresses to nearly 180 degrees, the folding force becomes stronger, and the end portions of the corrugated cardboard box S overlapping the gluing margin strip 334 and the gluing margin strip 334 are pressed and brought into close contact with each other, and both end portions of the corrugated cardboard box S are joined to become the corrugated box B. The corrugated box B is transferred to the counter-ejector section 61.

In the counter-ejector section 61, the corrugated box B detected as a non-defective product is sent to the hopper device 62. The corrugated box B sent to the hopper device 62 is stacked on the elevator 63 in a state where the tip portion in the transfer direction D hits the front plate and is shaped by the square plate. When a predetermined number of corrugated boxes B are stacked on the elevator 63, the elevator 63 is lowered, and the predetermined number of corrugated boxes B are discharged as one batch by the carry-out conveyor 64 and sent to the subsequent process of the box making machine 10.

### Slotter Creaser Section

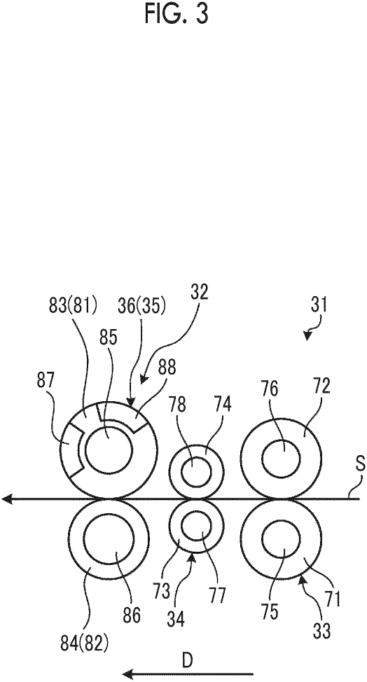

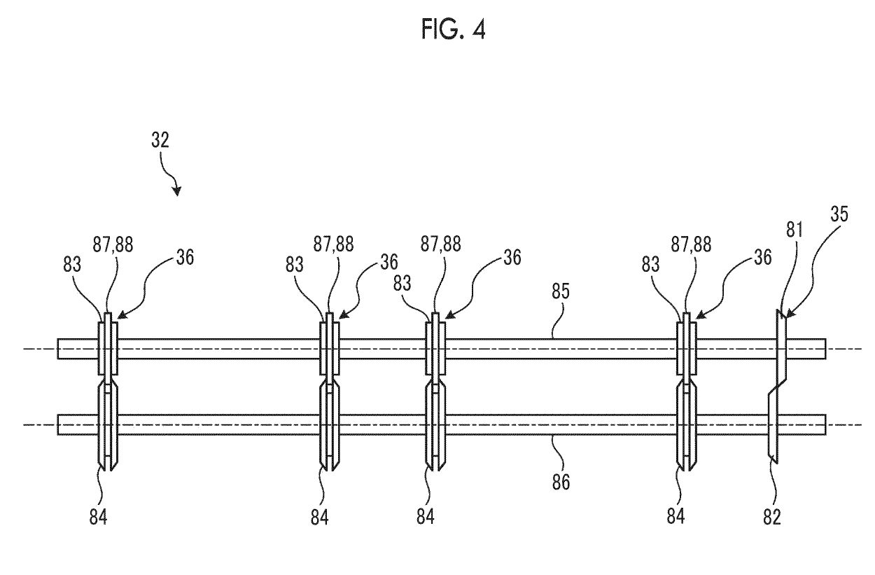

Here, the slotter creaser section 31 having the slotter device of the present embodiment will be described in detail. FIG. 3 is a schematic side view showing the slotter device of the present embodiment, and FIG. 4 is a schematic front view showing the slotter device.

As shown in FIGS. 3 and 4, the slotter creaser section 31 has the slotter device 32, and the corrugated cardboard box S is subjected to the creasing line process and the groove cutting process. The slotter creaser section 31 has a first creasing roll 33, a second creasing roll 34, a slitter head 35, and a slotter head 36.

The first creasing roll 33 has a creasing roll main body 71 and a receiving roll 72. The creasing roll main body 71 is located below, and the receiving roll 72 is located above. The creasing roll main body 71 and the receiving roll 72 have a disk shape, and a plurality of sets are disposed in the horizontal direction orthogonal to the transfer direction D of the corrugated cardboard box S. The second creasing roll 34 has a creasing roll main body 73 and a receiving roll 74. The creasing roll main body 73 is located below, and the receiving roll 74 is located above. The creasing roll main body 73 and the receiving roll 74 have a disk shape, and a plurality of sets are disposed in the horizontal direction orthogonal to the transfer direction D of the corrugated cardboard box S. An outer diameter of the first creasing roll 33 is larger than an outer diameter of the second creasing roll 34.

The lower roll shaft 75 and the upper roll shaft 76 are vertically spaced parallel to each other at predetermined intervals, and are disposed along the horizontal direction orthogonal to the transfer direction D of the corrugated cardboard box S, and each end portion in the axial direction is rotatably supported by a frame (not shown). A plurality of creasing roll main bodies 71 are fixed to the lower roll shaft 75 at predetermined intervals in the axial direction. A plurality of receiving rolls 72 are fixed to the upper roll shaft 76 at predetermined intervals in the axial direction. The lower roll shaft 77 and the upper roll shaft 78 are disposed on the downstream side of the corrugated cardboard box S in the transfer direction D from the lower roll shaft 75 and the upper roll shaft 76. The lower roll shaft 75 and the upper roll shaft 76 are vertically spaced parallel to each other at predetermined intervals, and are disposed along the horizontal direction orthogonal to the transfer direction D of the corrugated cardboard box S, and each end portion in the axial direction is rotatably supported by a frame (not shown). A plurality of creasing roll main bodies 73 are fixed to the lower roll shaft 77 at predetermined intervals in the axial direction. A plurality of receiving rolls 74 are fixed to the upper roll shaft 78 at predetermined intervals in the axial direction.

The creasing roll main body 71 and the receiving roll 72, and the creasing roll main body 73 and the receiving roll 74 are disposed so as to face each other vertically. The first creasing roll 33 and the second creasing roll 34 are disposed at the same positions in the axial direction of the roll shafts 75, 76, 77, and 78.

Therefore, when the corrugated cardboard box S is transferred between the creasing roll main body 71 and the receiving roll 72 of the first creasing roll 33, the outer peripheral portion of the creasing roll main body 71 and the outer peripheral portion of the receiving roll 72 sandwich the corrugated cardboard box S, and when the corrugated cardboard box S passes between the two, a creasing line is formed on the lower surface. Further, when the corrugated cardboard box S is transferred between the creasing roll main body 73 and the receiving roll 74 of the second creasing roll 34, the outer peripheral portion of the creasing roll main body 73 and the outer peripheral portion of the receiving roll 74 sandwich the corrugated cardboard box S, and when the corrugated cardboard box S passes between the two, a creasing line is reformed on the lower surface. In the corrugated cardboard box S, one creasing line is formed by forming the creasing line by the first creasing roll 33 and the second creasing roll 34 at the same position.

The slitter head 35 has a slitter upper blade 81 and a slitter lower blade 82. The slitter upper blade 81 is located above, and the slitter lower blade 82 is located below. The slitter upper blade 81 and the slitter lower blade 82 have a disk shape, and one set is disposed at the end portion of the corrugated cardboard box S in the horizontal direction orthogonal to the transfer direction D. The slitter head 35 is provided corresponding to the end portion in the width direction of the corrugated cardboard box S to be transferred by the slitter upper blade 81 and the slitter lower blade 82, and cuts the end portion of the corrugated cardboard box S in the width direction.

The slotter head 36 has an upper slotter head 83 and a lower slotter head 84. The upper slotter head 83 is located above and the lower slotter head 84 is located below. The upper slotter head 83 and the lower slotter head 84 have a disk shape, and four sets are disposed at predetermined intervals in the horizontal direction orthogonal to the transfer direction D of the corrugated cardboard box S. The slotter head 36 is provided by the upper slotter head 83 and the lower slotter head 84 corresponding to a predetermined position in the width direction of the corrugated cardboard box S to be transferred, and performs the groove cutting process at a predetermined position on the corrugated cardboard box S, and performs the gluing margin strip process.

The upper slotter shaft 85 and the lower slotter shaft 86 are vertically spaced parallel to each other at predetermined intervals, and are disposed along the horizontal direction orthogonal to the transfer direction D of the corrugated cardboard box S, and each end portion in the axial direction is rotatably supported by a frame (not shown). The upper slotter shaft 85 is fixed to the slitter upper blade 81 and four upper slotter heads 83 at predetermined intervals in the axial direction. The lower slotter shaft 86 is fixed to the slitter lower blade 82 and the four lower slotter heads 84 at predetermined intervals in the axial direction. The slitter upper blade 81 and the slitter lower blade 82, and the upper slotter head 83 and the lower slotter head 84 are disposed so as to face each other vertically. The slitter head 35 and the slotter head 36 are disposed at the same positions as the first creasing roll 33 and the second creasing roll 34 in the horizontal direction orthogonal to the transfer direction D of the corrugated cardboard box S.

The slotter head 36 is provided with two slotter knives 87 and 88 respectively mounted on the outer peripheral portion of the upper slotter head 83. The slitter head 35 is disposed at one end portion in the horizontal direction orthogonal to the transfer direction D of the corrugated cardboard box S. Three of the four slotter heads 36 have slotter knives 87 and 88 used for groove cutting process of the corrugated cardboard box S and are disposed in an intermediate portion in the horizontal direction orthogonal to the transfer direction D of the corrugated cardboard box S. Further, in one of the four slotter heads 36, the slotter knives 87 and 88 includes a glue margin knife (not shown) for the gluing margin strip process of the corrugated cardboard box S, and is disposed at the other end portion in the horizontal direction orthogonal to the transfer direction D of the corrugated cardboard box S.

Therefore, when the corrugated cardboard box S is transferred between the slitter upper blade 81 and the slitter lower blade 82 of the slitter head 35, the outer peripheral portion of the slitter upper blade 81 and the outer peripheral portion of the slitter lower blade 82 sandwich the corrugated cardboard box S, and when the corrugated cardboard box S passes between the two, the end portion of the corrugated cardboard box S is cut by the slitter upper blade 81 and the slitter lower blade 82. Further, when the corrugated cardboard box S is transferred between the upper slotter head 83 and the lower slotter head 84 of the slotter head 36, the outer peripheral portion of the upper slotter head 83 and the outer peripheral portion of the lower slotter head 84 sandwich the corrugated cardboard box S, and when the corrugated cardboard box S passes between the two, the corrugated cardboard box S is subjected to the groove cutting process by the slotter knives 87 and 88, and the gluing margin strip process.

By the way, the box making machine 10 can process the corrugated cardboard boxs S having a plurality of different sizes to manufacture the corrugated box B. In the corrugated cardboard boxs S having different sizes, the positions of the grooves 331a, 331b, 332a, 332b, 333a, and 333b, and the notches 334a and 334b are different in the transfer direction D of the corrugated cardboard box S. Therefore, when the size of the corrugated cardboard box S to be processed is changed, it is necessary to adjust the relative positions in the circumferential direction of the two slotter knives 87 and 88 mounted on the upper slotter head 83 of the slotter head 36.

### Configuration of Slotter Head

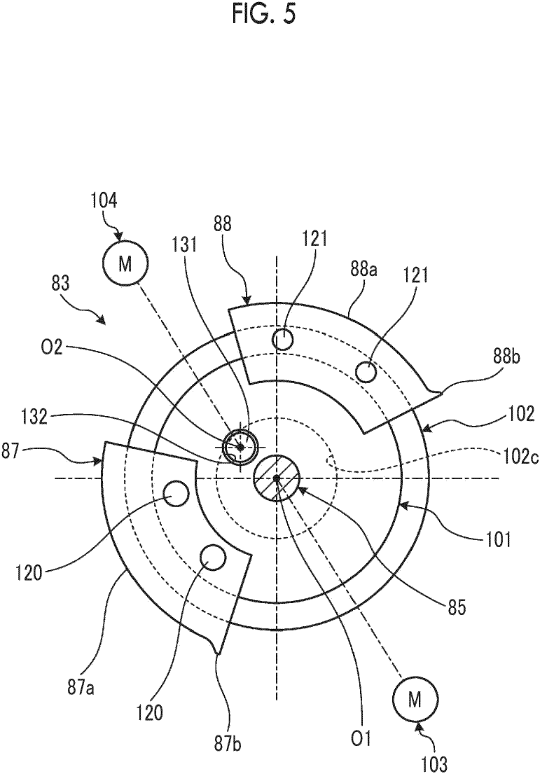

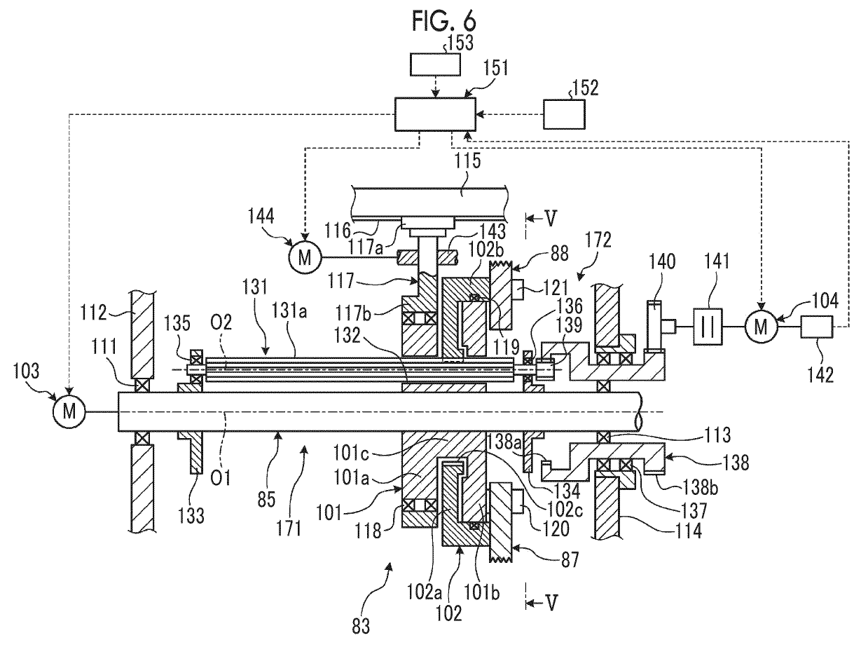

FIG. 5 is a front view of the slotter head of the present embodiment, and FIG. 6 is a sectional view showing a cross section of the slotter head taken along line VI-VI of FIG. 5.

As shown in FIGS. 5 and 6, the upper slotter head 83 has two slotter knives 87 and 88 mounted on the outer peripheral portion thereof. In the present embodiment, the first slotter knife 87 is fixed to the upper slotter head 83, and the second slotter knife 88 is movably supported with respect to the first slotter knife 87 in the circumferential direction.

The upper slotter head 83 includes a fixed slotter knife base 101, a first slotter knife (first cutting blade) 87, a moving slotter knife base 102, a second slotter knife (second cutting blade) 88, a first drive device 103, and a second drive device 104.

The upper slotter shaft (first rotary shaft) 85 has one end portion in the axial direction, which is rotatably supported on the frame 112 by a bearing 111 and the other end portion in the axial direction, which is rotatably supported on the frame 114 by a bearing 113. The upper slotter shaft 85 has the fixed slotter knife base 101 mounted on the outer peripheral portion to be integrally rotatable between the frame 112 and 114. The fixed slotter knife base 101 has a disk shape, and is configured by integrally connecting the first support portion 101a and the second support portion 101b by a connection portion 101c. The upper slotter shaft 85 is rotatable about the center 01, and the fixed slotter knife base 101 is rotatable about the center 01 together with the upper slotter shaft 85. A guide rail 116 is fixed to the upper frame 115 along the horizontal direction (axial direction of the upper slotter shaft 85) orthogonal to the transfer direction D of the corrugated cardboard box S. In the guide member 117, the guide portion 117a at the upper end portion thereof is movably supported by the guide rail 116. The guide member 117 is provided with a ring-shaped annular portion 117b at the lower end portion thereof, and in the annular portion 117b, the first support portion 101a of the fixed slotter knife base 101 is rotatably supported by the bearing 118 at the inner peripheral portion thereof.

In the fixed slotter knife base 101, the moving slotter knife base 102 is rotatably supported by the bearing 119 on the outer peripheral portion of the second support portion 101b. The moving slotter knife base 102 is rotatably supported concentrically with the center 01 of the fixed slotter knife base 101. The moving slotter knife base 102 can rotate relative to the fixed slotter knife base 101 in the circumferential direction, but cannot move relative thereto in the axial direction. The moving slotter knife base 102 has a disk shape with a hole portion formed at the central portion, and is configured by integrally connecting the annular portion 102b to the outer peripheral portion of the disk plate portion 102a. Then, in the fixed slotter knife base 101, the first slotter knife 87 is fixed to the end surface of the outer peripheral portion of the second support portion 101b by a plurality of bolts 120. Further, in the moving slotter knife base 102, the second slotter knife 88 is fixed to the end surface of the annular portion 102b by a plurality of bolts 121. The first slotter knife 87 and the second slotter knife 88 are disposed so as to be offset in the circumferential direction, and are disposed at the same position in the axial direction.

The first slotter knife 87 and the second slotter knife 88 have an arc shape, and slotter knife blades 87a and 88a and tips 87b and 88b are provided on the outer peripheral portion thereof. The slotter knife blades 87a and 88a are provided on the outer peripheral portions of the first slotter knife 87 and the second slotter knife 88 in the circumferential direction, and outer diameter dimensions from the center of the upper slotter shaft 85 are the same in the circumferential direction. The tips 87b and 88b are provided at one end portion of the outer peripheral portion of the first slotter knife 87 and the second slotter knife 88 in the circumferential direction, and the outer diameter dimension from the center of the upper slotter shaft 85 is a dimension larger than the outer diameter dimension of the slotter knife blades 87a and 88a. It is preferable that the slotter knife blades 87a and 88a, and the tips 87b and 88b have outer diameters that are smoothly continuous with a curved line without a step. Although not shown, the first slotter knife 87 and the second slotter knife 88 can be replaced by detachably providing the tips 87b and 88b with respect to the slotter knife blades 87a and 88a.

The moving slotter knife base 102 is provided with an internal gear 102c on the inner peripheral portion of the disk plate portion 102a. The spline shaft (second rotary shaft) 131 is adjacent to the upper slotter shaft 85 with a predetermined gap, and is disposed parallel to the upper slotter shaft 85. The fixed slotter knife base 101 is formed with a through-hole 132 penetrating in the axial direction. The spline shaft 131 penetrates through the through-hole 132 of the fixed slotter knife base 101 with a gap. Disk-shaped support members 133 and 134 are fixed to each end portion of the upper slotter shaft 85 in the axial direction. Each end portion of the spline shaft 131 in the axial direction is rotatably supported by the support members 133 and 134 by bearings 135 and 136. In the spline shaft 131, the external gear 131a meshes with the internal gear 102c of the moving slotter knife base 102. The spline shaft 131, together with the upper slotter shaft 85 and the fixed slotter knife base 101, is rotatably (revolves) supported around the center 01 and rotatably (rotates) supported around the center 02.

In the frame 114, the geared hollow shaft 138 is rotatably supported by the bearing 137, and in the geared hollow shaft 138, the upper slotter shaft 85 is rotatably supported by the bearing 113. The upper slotter shaft 85 may be directly rotatably supported by the frame 114. The upper slotter shaft 85 and the geared hollow shaft 138 are relatively rotatable about the center 01. The geared hollow shaft 138 has a cylindrical shape, and an internal gear (drive gear) 138a is provided at one end portion in the axial direction, and an external gear 138b is provided at the other end portion in the axial direction. The spline shaft 131 is provided with a pinion gear (driven gear) 139 at one end portion in the axial direction, and the pinion gear 139 of the spline shaft 131 meshes with the internal gear 138a of the geared hollow shaft 138.

The first drive device 103 can rotate the fixed slotter knife base 101 via the upper slotter shaft 85. The second drive device 104 can rotate the moving slotter knife base 102 via the spline shaft 131. That is, the first drive device 103 is, for example, a motor and a speed reducer. The first drive device 103 can rotate the fixed slotter knife base 101 fixed to the upper slotter shaft 85 by driving and rotating the upper slotter shaft 85. The second drive device 104 is, for example, a motor and a speed reducer. The second drive device 104 can drive and rotate the drive gear 140. The drive gear 140 meshes with the external gear 138b of the geared hollow shaft 138. Therefore, the rotational force of the drive gear 140 is transmitted to the spline shaft 131 via the geared hollow shaft 138 and the pinion gear 139. By rotating the spline shaft 131, the moving slotter knife base 102 that meshes with the spline shaft 131 can be rotated. Further, a torque limiter (overload protection device) 141 is provided between the second drive device 104 and the drive gear 140. Further, the second drive device 104 is provided with a torque sensor (overload protection device) 142.

In this case, the first drive device 103 and the second drive device 104 are provided on the frames 112 and 114, and the like. The driving force transmission system 171 that transmits the driving rotational force of the first drive device 103 to the fixed slotter knife base 101, and the driving force transmission system 172 that transmits the driving rotational force of the second drive device 104 to the moving slotter knife base 102 are independent. That is, the driving force transmission system 171 and the driving force transmission system 172 do not intersect, and by controlling the first drive device 103 and the second drive device 104 individually, the rotation speeds of the fixed slotter knife base 101 and the moving slotter knife base 102 can be individually adjusted. In this case, the torque limiter 141 and the torque sensor 142 are provided in the driving force transmission system 172 that transmits the driving force of the second drive device 104. Only one of the torque limiter 141 and the torque sensor 142 may be provided.

Further, the screw shaft 143 is disposed in the horizontal direction (axial direction of the upper slotter shaft 85) orthogonal to the transfer direction D of the corrugated cardboard box S. The screw shaft 143 is screwed into the guide member 117. The screw shaft 143 can be driven and rotated by the third drive device 144. Therefore, by rotating the screw shaft 143 forward or reverse by the third drive device 144, the guide member 117 to which the screw shaft 143 is screwed is moved in the horizontal direction orthogonal to the transfer direction D of the corrugated cardboard box S, and the upper slotter head 83 can be moved in the horizontal direction orthogonal to the transfer direction D of the corrugated cardboard box S.

The control device 151 can drive and control the first drive device 103, the second drive device 104, and the third drive device 144. In the control device 151, the manufacturing information of the corrugated cardboard box S is input from the production control device 152. The manufacturing information of the corrugated cardboard box S includes the size of the corrugated cardboard box S to be manufactured and the positions of the grooves 331a, 331b, 332a, 332b, 333a, and 333b, and the notches 334a and 334b. The size of the corrugated cardboard box S to be manufactured and the positions of the grooves 331a, 331b, 332a, 332b, 333a, and 333b, and the notches 334a and 334b are relative position information in the circumferential direction of the first slotter knife 87 and the second slotter knife 88. The control device 151 drives and controls the first drive device 103 and the second drive device 104 based on the relative position information in the circumferential direction of the first slotter knife 87 and the second slotter knife 88 input from the production control device 152. At this time, the control device 151 inputs the torque of the second drive device 104 measured by the torque sensor 142. When the torque input from the torque sensor 142 exceeds the preset upper limit torque, the control device 151 stops the first drive device 103 and the second drive device 104, and the entire box making machine 10 is stopped.

Further, the control device 151 is connected to the operation device 153, and the command information output by the operator operating the operation device 153 is input. The command information includes the relative position information of the first slotter knife 87 and the second slotter knife 88 in the circumferential direction. The control device 151 may be configured to drive and control the first drive device 103 and the second drive device 104 based on the relative position information of the first slotter knife 87 and the second slotter knife 88 in the circumferential direction input from the operation device 153.

### Modified Example of Slotter Head

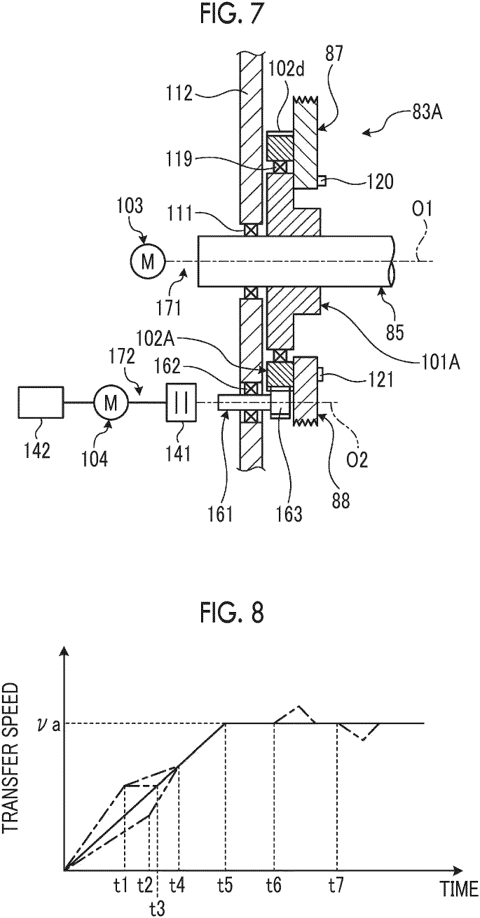

FIG. 7 is a sectional view showing a cross section of the slotter head of a modified example.

In the modified example of the slotter head, as shown in FIG. 7, an upper slotter head 83A includes a fixed slotter knife base 101A, a first slotter knife 87, a moving slotter knife base 102A, a second slotter knife 88, a first drive device 103, and a second drive device 104.

One end portion of the upper slotter shaft 85 in the axial direction is rotatably supported by the frame 112 by the bearing 111. The upper slotter shaft 85 is mounted on the outer peripheral portion of the fixed slotter knife base 101A so as to be integrally rotatable. The upper slotter shaft 85 and the fixed slotter knife base 101A are rotatable about the center 01. The moving slotter knife base 102A is rotatably supported on the outer peripheral portion of the fixed slotter knife base 101A by the bearing 119. The moving slotter knife base 102A is rotatably supported concentrically with the center 01 of the fixed slotter knife base 101. The moving slotter knife base 102A can rotate relative to the fixed slotter knife base 101 in the circumferential direction, but cannot move relative thereto in the axial direction. The moving slotter knife base 102A has a ring shape. Then, in the fixed slotter knife base 101A, the first slotter knife 87 is fixed to the end surface of the outer peripheral portion by a plurality of bolts 120. Further, in the moving slotter knife base 102A, the second slotter knife 88 is fixed to the end surface by a plurality of bolts 121. The first slotter knife 87 and the second slotter knife 88 are disposed so as to be offset in the circumferential direction, and are disposed at the same position in the axial direction.

The moving slotter knife base 102A is provided with an external gear 102d on the outer peripheral portion. The second rotary shaft 161 is disposed parallel to the upper slotter shaft 85. The second rotary shaft 161 is rotatably supported by the frame 112 by the bearing 162. A pinion gear (external gear) 163 is fixed to the second rotary shaft 161, and the pinion gear 163 meshes with the external gear 102d of the moving slotter knife base 102A. The second rotary shaft 161 is rotatably supported around the center 02.

The first drive device 103 can rotate the fixed slotter knife base 101A via the upper slotter shaft 85. The second drive device 104 can rotate the moving slotter knife base 102A via the second rotary shaft 161. The driving force transmission system 171 that transmits the driving rotational force of the first drive device 103 to the fixed slotter knife base 101, and the driving force transmission system 172 that transmits the driving rotational force of the second drive device 104 to the moving slotter knife base 102 are independent of each other. The driving force transmission system 172 is provided with a torque limiter 141 and a torque sensor 142.

### Action of Slotter Head

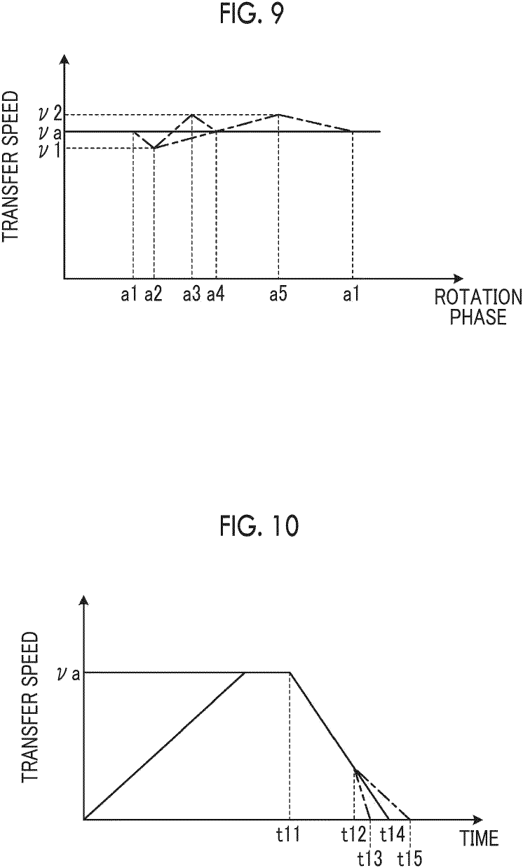

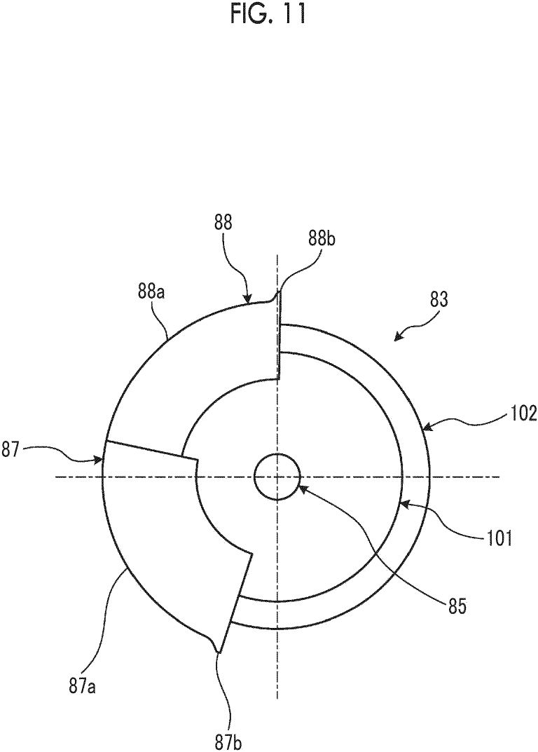

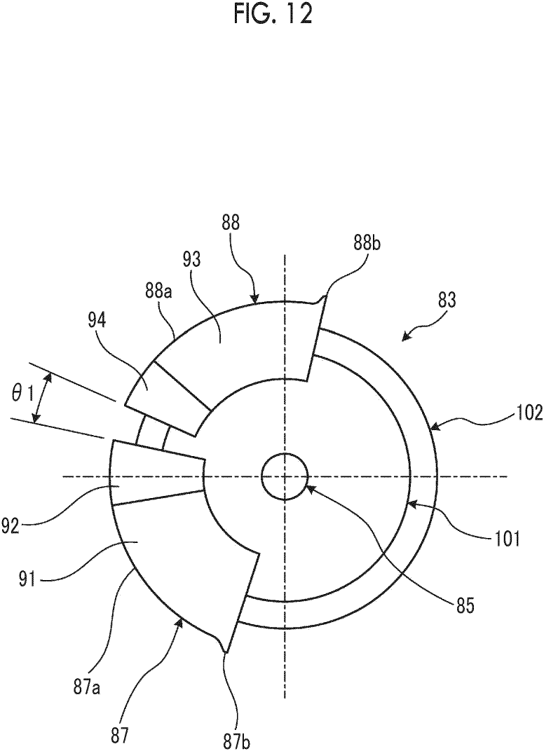

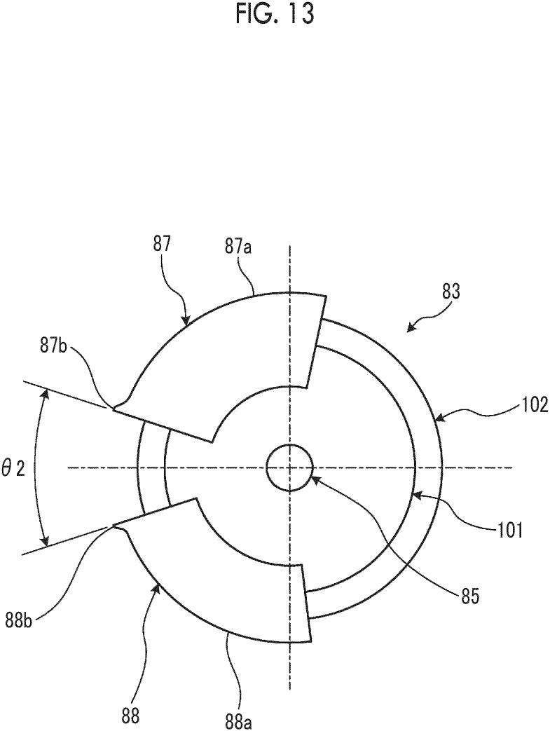

FIG. 8 is a graph showing the rotation control of the slotter knife when the slotter device is started, FIG. 9 is a graph showing the rotation control of the slotter knife when the slotter device is operated, and FIG. 10 is a graph showing the rotation control of the slotter knife when the slotter device is stopped. FIG. 11 is a schematic view showing a first stop state of the slotter device, FIG. 12 is a schematic view showing a second stop state of the slotter device, and FIG. 13 is a schematic view showing a third stop state of the slotter device.

As shown in FIGS. 5 and 6, the relative position information of the first slotter knife 87 and the second slotter knife 88 in the circumferential direction is input into the control device 151. When the box making machine 10 (slotter creaser section 31) is started, the control device 151 drives and rotates the first slotter knife 87 by the first drive device 103 via the fixed slotter knife base 101, and drives and rotates the second slotter knife 88 by the second drive device 104 via the moving slotter knife base 102. At this time, by making the rotation speed of the second slotter knife 88 by the second drive device 104 different from the rotation speed of the first slotter knife 87 by the first drive device 103, the relative position of the second slotter knife 88 with respect to the first slotter knife 87 is adjusted.

Hereinafter, the phase control of the first slotter knife 87 and the second slotter knife 88 by the control device 151 will be specifically described. Here, narrowing the interval between the first slotter knife 87 and the second slotter knife 88 means that the interval between the end portion of the tip 87b of the first slotter knife 87 and the end portion of the second slotter knife 88 on the tip 88b side is narrowed. On the other hand, widening the interval between the first slotter knife 87 and the second slotter knife 88 means the interval between the end portion of the tip 87b of the first slotter knife 87 and the end portion of the second slotter knife 88 on the tip 88b side is widened.

As shown by a solid line in FIGS. 5 and 8, the rotation speed of the first slotter knife 87 is increased by the first drive device 103 at a first increasing rate, and is maintained at a constant operating speed va at time t5. Here, when the interval between the first slotter knife 87 and the second slotter knife 88 is narrowed, as shown by an one-dotted chain line in FIGS. 5 and 8, the rotation speed of the second slotter knife 88 is increased at a second increasing rate higher than the first increasing rate by the second drive device 104, is maintained at a constant operating speed at time t1, and then is increased at the first increasing rate similar to that of the first slotter knife 87 at time t3, and is maintained at a constant operating speed va at time t5. On the other hand, when the interval between the first slotter knife 87 and the second slotter knife 88 is widened, as shown by a two-dotted chain line in FIGS. 5 and 8, the rotation speed of the second slotter knife 88 is increased by the second drive device 104 at a third increasing rate lower than the first increasing rate, is increased at a fourth increasing rate higher than the first increasing rate at time t2, and then is increased at the first increasing rate similar to that of the first slotter knife 87 at time t4, and is maintained at the constant operating speed va at time t5. The rotation speed of the second slotter knife 88 may be increased by the second drive device 104 at the second increasing rate, and then increased at a predetermined increasing rate at time t1.

Then, the control device 151 drives and controls the first drive device 103 and the second drive device 104 when the box making machine 10 (slotter creaser section 31) is operated, so as to rotate the first slotter knife 87 and the second slotter knife 88 at a speed corresponding to the constant operating speed va. However, the interval between the first slotter knife 87 and the second slotter knife 88 can be adjusted while the box making machine 10 is operated. For example, when the interval between the first slotter knife 87 and the second slotter knife 88 is narrowed, as shown by the one-dotted chain line in FIG. 8, the rotation speed of the second slotter knife 88 is temporarily increased by the second drive device 104 at time t6. On the other hand, when the interval between the first slotter knife 87 and the second slotter knife 88 is widened, as shown by the two-dotted chain line in FIG. 8, the rotation speed of the second slotter knife 88 is temporarily decreased by the second drive device 104 at time t7.

Then, as shown in FIGS. 5 and 6, the control device 151 rotates the first slotter knife 87 once by the first drive device 103 and rotates the second slotter knife 88 once by the second drive device 104 when the box making machine 10 (slotter creaser section 31) is operated, the rotation speed of the second slotter knife 88 by the second drive device 104 is reduced within a predetermined phase angle range.

The first slotter knife 87 and the second slotter knife 88 have the slotter knife blades 87a and 88a, and the tips 87b and 88b. In this case, the peripheral speeds of the slotter knife blades 87a and 88a are the same as the transfer speed of the corrugated cardboard box S, but the tips 87b and 88b have a larger outer diameter dimension than that of the slotter knife blades 87a and 88a, so that even if the first slotter knife 87 and the second slotter knife 88 are rotated at the same rotation speed, the peripheral speed of the tip portions of the tips 87b and 88b in the radial direction is higher than the peripheral speed of the tip portions of the slotter knife blades 87a and 88a in the radial direction. Therefore, when the slotter knife blade 88a of the second slotter knife 88 comes into contact with the corrugated cardboard box S to perform the groove cutting process, and then the tip 88b separates from the corrugated cardboard box S, since the peripheral speed of the tip 88b is higher than the transfer speed of the corrugated cardboard box S, the tip 88b rotating at high speed may kick up and damage the downstream end of the grooves 331b, 332b, and 333b of the corrugated cardboard box S in the transfer direction D.

Therefore, the control device 151 adjusts the rotation speeds of the fixed slotter knife base 101 and the moving slotter knife base 102 by the first drive device 103 and the second drive device 104 so that the rotation speed at least when the tip 88b separates from the corrugated cardboard box S is lower than the rotation speed when the slotter knife blade 88a comes into contact with the corrugated cardboard box S. In FIG. 8, the range from the angle a1 to the angle a1 is a range of one rotation of the second slotter knife 88. The range from the angle a1 to the angle a2 is a range until the tip 88b of the second slotter knife 88 comes into contact with and separates from the corrugated cardboard box S, and the range from the angle a2 to the angle a1 is a range in which the tip 88b of the second slotter knife 88 does not come into contact with the corrugated cardboard box S.

That is, as shown by the solid line in FIGS. 5 and 9, the first slotter knife 87 is maintained at a constant operating speed va by the first drive device 103. On the other hand, as shown by the one-dotted chain line in FIGS. 5 and 9, the operating speed of the second slotter knife 88 is lowered by the second drive device 104 to v1 in the range from the angle a1 to the angle a2 in which the tip 88b comes into contact with the corrugated cardboard box S from the state where the second slotter knife 88 is maintained at a constant operating speed va by the second drive device 104. After that, the operating speed of the second slotter knife 88 by the second drive device 104 is increased to v2 in the range from the angle a2 to the angle a3 until the second slotter knife 88 comes into contact with and separates from the corrugated cardboard box S, and then the operating speed of the second slotter knife 88 by the second drive device 104 is lowered and maintained at a constant operating speed va in the range from the angle a3 to the angle a4.

Further, the control method of the operating speed of the second slotter knife 88 by the second drive device 104 is not limited to the above-mentioned method. As shown by the two-dotted chain line in FIGS. 5 and 9, the operating speed of the second slotter knife 88 is lowered to v1 by the second drive device 104 in the range from the angle a1 to the angle a2 in which until the tip 88b comes into contact with and separates from the corrugated cardboard box S from the state where the second slotter knife 88 is maintained at a constant operating speed va by the second drive device 104. Then, the operating speed of the second slotter knife 88 is increased to v2 by the second drive device 104 in the range from the angle a2 to the angle a5 in which the second slotter knife 88 does not come into contact with the corrugated cardboard box S, and then the operating speed of the second slotter knife 88 is lowered and maintained at a constant operating speed va by the second drive device 104 in the range from the angle a5 to the angle a1.

Further, as shown in FIGS. 5 and 6, when the box making machine 10 (slotter creaser section 31) is stopped, the control device 151 adjusts the relative position of the second slotter knife 88 with respect to the first slotter knife 87 by making the rotation speed of the second slotter knife 88 by the second drive device 104 different from the rotation speed of the first slotter knife 87 by the first drive device 103.

As shown by the solid lines in FIGS. 5 and 10, the first drive device 103 and the second drive device 104 maintain the first slotter knife 87 and the second slotter knife 88 at a constant operating speed va. Then, at time t11, the rotation speed of the first slotter knife 87 is lowered by the first drive device 103 at a first decreasing rate, and at time t14, the operating speed is stopped at 0. Here, when the interval between the first slotter knife 87 and the second slotter knife 88 is widened, as shown by the two-dotted chain line in FIGS. 5 and 10, at time t11, the rotation speed of the second slotter knife 88 is decreased by the second drive device 104 at the same first decreasing rate as the first slotter knife 87, at time t12, decreased at a third decreasing rate lower than the first decreasing rate, and at time t15, the operating speed is stopped at 0. On the other hand, when the interval between the first slotter knife 87 and the second slotter knife 88 is narrowed, as shown by the one-dotted chain line in FIGS. 5 and 10, at time t11, the rotation speed of the second slotter knife 88 is decreased at the same first decreasing rate as that of the first slotter knife 87 by the second drive device 104, at time t12, decreased at the second decreasing rate that is higher than the first decreasing rate, and at time t13, the operating speed is stopped at 0.

When the box making machine 10 (slotter creaser section 31) is stopped, the maintainability is improved by changing the interval between the first slotter knife 87 and the second slotter knife 88. For example, as shown in FIG. 11, when the interval between the first slotter knife 87 and the second slotter knife 88 is widened, the interval between the end portion of the first slotter knife 87 not on the tip 87b side and the end portion of the second slotter knife 88 not on the tip 88b side is narrowed, that is, the operation is stopped in the contact state. The first slotter knife 87 and the second slotter knife 88 are stopped so as to be located on the left side of FIG. 10. Then, when the maintenance opening is provided at this position, the first slotter knife 87 and the second slotter knife 88 can be maintained at the same time.

Further, as shown in FIG. 12, the first slotter knife 87 and the second slotter knife 88 may be configured of knife main bodies 91 and 93, and split knife bodies 92 and 94. In this case, the interval between the first slotter knife 87 and the second slotter knife 88 is widened so that the operation is stopped in a state where a predetermined gap (angle) θ1 is secured between the end portion of the first slotter knife 87 not on the tip 87b side and the end portion of the second slotter knife 88 not on the tip 88b side. Then, when the maintenance opening is provided at this position, the work of removing and replacing the split knife bodies 92 and 94 from the knife main bodies 91 and 93 of the first slotter knife 87 and the second slotter knife 88 can be s performed at the same time.

Further, as shown in FIG. 13, the interval between the first slotter knife 87 and the second slotter knife 88 is narrowed, and the operation is stopped in a state where a predetermined gap (angle) θ2 is secured between the end portion of the first slotter knife 87 on the tip 87b side and the end portion of the second slotter knife 88 on the tip 88b side. Then, when the maintenance opening is provided at this position, the work of replacing the tips 87b and 88b of the first slotter knife 87 and the second slotter knife 88 can be performed at the same time. Further, based on the manufacturing information of the corrugated cardboard box S from the production control device 152, the first slotter knife 87 and the second slotter knife 88 may move to predetermined positions and stop depending on the presence or absence of the split knife bodies 92 and 94 in the next grooving process.

When the box making machine 10 is stopped, when maintenance work or replacement work of the first slotter knife 87 and the second slotter knife 88 is performed, it is preferable to provide the operation device 153 with a maintenance work button, a replacement work button, or the like. When the operator operates various buttons, when the box making machine 10 is stopped, the first slotter knife 87 and the second slotter knife 88 are moved to predetermined positions and then stopped, which can improve operability.

### Actions and Effects of the Present Embodiment

The slotter head according to the first aspect includes the fixed slotter knife base 101 that has a disk shape and is rotatably supported, the first slotter knife (first cutting blade) 87 mounted on the outer peripheral portion of the fixed slotter knife base 101, the moving slotter knife base 102 that is movably supported by the fixed slotter knife base 101 in the circumferential direction, the second slotter knife (second cutting blade) 88 that is mounted on the outer peripheral portion of the moving slotter knife base 102, the first drive device 103 that rotationally drives the fixed slotter knife base 101, and the second drive device 104 that rotationally drives the moving slotter knife base 102.

The slotter head according to the first aspect can easily adjust the relative position in the circumferential direction between the first slotter knife 87 and the second slotter knife 88 by rotating the first slotter knife 87 or the second slotter knife 88 by the first drive device 103 or the second drive device 104. Further, by rotating the first drive device 103 and the second slotter knife 88, the first slotter knife 87 and the second slotter knife 88 can be synchronously rotated. That is, the drive system of the first slotter knife 87 and the drive system of the second slotter knife 88 are independent. Therefore, a gear mechanism for controlling the relative positions of the first slotter knife 87 and the second slotter knife 88 becomes unnecessary, and the device can be simplified.

In the slotter head according to the second aspect, the upper slotter shaft (first rotary shaft) 85 is fixed to the center O1 of the fixed slotter knife base 101, and the moving slotter knife base 102 is rotatably supported concentrically with the fixed slotter knife base 101. At the same time, the internal gear 102c is provided on the inner peripheral portion of the moving slotter knife base 102, the external gear 131a of the spline shaft (second rotary shaft) 131 meshes with the internal gear 102c, the first drive device 103 can rotate the upper slotter shaft 85, and the second drive device 104 can rotate the spline shaft 131. Therefore, with a simple configuration, the fixed slotter knife base 101 can be rotated by the first drive device 103 via the upper slotter shaft 85, and the moving slotter knife base 102 can be rotated by the second drive device 104 via the spline shaft 131.

In the slotter head according to the third aspect, the spline shaft 131 is disposed in parallel adjacent to the upper slotter shaft 85 and penetrates the fixed slotter knife base 101, and each end portion thereof in the axial direction is rotatably supported by the support members 133 and 134 of the upper slotter shaft 85. Therefore, by disposing the spline shaft 131 adjacent to the upper slotter shaft 85, the device can be made compact.

In the slotter head according to the fourth aspect, the pinion gear (driven gear) 139 is fixed to the end portion of the spline shaft 131 in the axial direction, the geared hollow shaft 138 is rotatably supported concentrically with the upper slotter shaft 85, the internal gear (drive gear) 138a provided on the inner peripheral portion of the geared hollow shaft 138 meshes with the pinion gear 139, and the second drive device 104 can rotate the geared hollow shaft 138. Therefore, the driving force transmission system 172 from the second drive device 104 to the moving slotter knife base 102 can be appropriately configured.

In the slotter head according to the fifth aspect, the upper slotter shaft 85 is fixed to the center O1 of the fixed slotter knife base 101A, and the moving slotter knife base 102A is rotatably supported concentrically with the fixed slotter knife base 101A. At the same time, the external gear 102d is provided on the outer peripheral portion of the moving slotter knife base 102A, the pinion gear (external gear) 163 of the second rotary shaft 161 meshes with the external gear 102d, the first drive device 103 can rotate the upper slotter shaft 85, and the second drive device 104 can rotate the second rotary shaft 161. Therefore, with a simple configuration, the fixed slotter knife base 101 can be rotated by the first drive device 103 via the upper slotter shaft 85, and the moving slotter knife base 102 can be rotated by the second drive device 104 via the second rotary shaft 161.

In the slotter head according to the sixth aspect, the torque limiter 141 and the torque sensor 142 as the overload protection device are provided in the driving force transmission system 172 that transmits the driving force of the second drive device 104 to the moving slotter knife base 102. Therefore, even if the rotation speeds of the fixed slotter knife base 101 and the moving slotter knife base 102 vary, and the first slotter knife 87 and the second slotter knife 88 come into contact with each other, the torque limiter 141 and the torque sensor 142 operate so that damage to the first slotter knife 87 and the second slotter knife 88 can be suppressed. In addition, damage to the driving force transmission systems 171 and 172 of the first slotter knife 87 and the second slotter knife 88 can be suppressed.

The slotter head according to the seventh aspect has the control device 151 that drives and controls the first drive device 103 and the second drive device 104, and the control device 151 adjusts the relative rotation speed between the fixed slotter knife base 101 and the moving slotter knife base 102 at the start of the rotation of the fixed slotter knife base 101 and the moving slotter knife base 102 by the first drive device 103 and the second drive device 104, so that the relative positions of the first slotter knife 87 and the second slotter knife 88 in the circumferential direction are adjusted. Therefore, the relative positions of the first slotter knife 87 and the second slotter knife 88 can be adjusted at the start of the rotation of the fixed slotter knife base 101 and the moving slotter knife base 102, the interval adjustment between the first slotter knife 87 and the second slotter knife 88, which is conventionally performed before the start of the operation of the box making machine, is not necessary. Therefore, the set time can be shortened and the work efficiency can be improved.

The slotter head according to the eighth aspect has the control device 151 that drives and controls the first drive device 103 and the second drive device 104, the control device 151 adjusts the relative rotation speed between the fixed slotter knife base 101 and the moving slotter knife base 102 when controlling the fixed slotter knife base 101 and the moving slotter knife base 102 by the first drive device 103 and the second drive device 104 at the same constant rotation speed, so that the relative positions of the first slotter knife 87 and the second slotter knife 88 in the circumferential direction are adjusted. Therefore, when the fixed slotter knife base 101 and the moving slotter knife base 102 are rotated at the same constant rotation speed, by adjusting the relative positions of the first slotter knife 87 and the second slotter knife 88, during the operation of the box making machine 10, the relative positions of the first slotter knife 87 and the second slotter knife 88 can be corrected, and the machining accuracy can be improved.

The slotter head according to the ninth aspect has the control device 151 that drives and controls the first drive device 103 and the second drive device 104, and the control device 151 adjusts the relative rotation speed between the fixed slotter knife base 101 and the moving slotter knife base 102 when the rotation of the fixed slotter knife base 101 and the moving slotter knife base 102 is stopped by the first drive device 103 and the second drive device 104, so that the relative positions of the first slotter knife 87 and the second slotter knife 88 in the circumferential direction are adjusted. Therefore, when the rotation of the fixed slotter knife base 101 and the moving slotter knife base 102 is stopped, the relative positions of the first slotter knife 87 and the second slotter knife 88 are adjusted, so that after the rotation of the fixed slotter knife base 101 and the moving slotter knife base 102 is stopped, the first slotter knife 87 and the second slotter knife 88 can be stopped at a desired position, maintenance work and replacement work of the first slotter knife 87 and the second slotter knife 88 can be easily performed in a short time, and the work efficiency can be improved.

The slotter head according to the tenth aspect has the control device 151 that drives and controls the second drive device 104, the second slotter knife 88 has the slotter knife blade 88a having an arc shape and the tip 88b provided at the end portion of the slotter knife blade 88a in the circumferential direction, and the control device 151 adjusts the rotation speed of the moving slotter knife base 102 by the second drive device 104, so that at least the rotation speed when the tip 88b separates from the corrugated cardboard box S is lower than the rotation speed when the slotter knife blade 88a comes into contact with the corrugated cardboard box S. Therefore, the rotation speed when the tip 88b separates from the corrugated cardboard box S becomes low, and the occurrence of damage to the groove portion of the corrugated cardboard box S by the tip 88b when the corrugated cardboard box S performs the groove cutting process can be suppressed and the quality of the corrugated cardboard box S can be improved.

In the slotter head according to the eleventh aspect, the control device 151 drives and controls the first drive device 103 and the second drive device 104 based on the relative position information of the first slotter knife 87 and the second slotter knife 88 in the circumferential direction input from the production control device 152. Therefore, the relative position adjustment of the first slotter knife 87 and the second slotter knife 88 in the circumferential direction can be easily and highly accurately performed.

In the slotter head according to the twelfth aspect, the control device 151 drives and controls the first drive device 103 and the second drive device 104 based on the relative position information of the first slotter knife 87 and the second slotter knife 88 in the circumferential direction input from the operation device 153 operated by the operator. Therefore, the relative position adjustment of the first slotter knife 87 and the second slotter knife 88 in the circumferential direction can be easily and highly accurately performed.

The slotter device according to the thirteenth aspect includes the upper slotter shaft 85 and the lower slotter shaft 86 that are rotatably supported by the frame, and the upper slotter head 83 and the lower slotter head 84 which are fixed to the upper slotter shaft 85 and the lower slotter shaft 86, respectively to perform the groove cutting process of the corrugated cardboard box S. Therefore, since the drive system of the first slotter knife 87 and the drive system of the second slotter knife 88 are independent, in the upper slotter head 83, the gear mechanism for controlling the relative positions of the first slotter knife 87 and the second slotter knife 88 becomes unnecessary, and the slotter device can be simplified.

The box making machine according to the fourteenth aspect includes the sheet feeding section 11, the printing section 21, the slotter creaser section 31, the die cutting section 41, the folding section 51, and the counter-ejector section 61, and the slotter device 32 is provided in the slotter creaser section 31. Therefore, in the slotter creaser section 31, since the drive system of the first slotter knife 87 and the drive system of the second slotter knife 88 are independent, the upper slotter head 83 is not necessary to be provided with a gear mechanism for performing the relative position control between the first slotter knife 87 and the second slotter knife 88, and thereby the slotter device can be simplified.

In the above-described embodiments, the box making machine 10 includes the sheet feeding section 11, the printing section 21, the slotter creaser section 31, the die cutting section 41, the folding section 51, and the counter-ejector section 61, but is not limited thereto. For example, the presence or absence of the printing section 21, the die cutting section 41, the folding section 51, and the counter-ejector section 61 is not limited.

### Reference Signs List

10 box making machine

11 sheet feeding section

21 printing section

31 slotter creaser section

32 slotter device

33 first creasing roll

34 second creasing roll

35 slitter head

36 slotter head

41 die cutting section

51 folding section

61 counter-ejector section

71, 73 creasing roll main body

72, 74 receiving roll

75, 77 lower roll shaft

76, 78 upper roll shaft

81 slitter upper blade

82 slitter lower blade

83, 83A upper slotter head

84 lower slotter head

85 upper slotter shaft (first rotary shaft)

86 lower slotter shaft

87 first slotter knife (first cutting blade)

87a slotter knife blade

87b tip

88 second slotter knife (second cutting blade)

88a slotter knife blade

88b tip

91, 93 knife main body

92, 94 split knife body

101, 101A fixed slotter knife base

102, 102A moving slotter knife base

103 first drive device

104 second drive device

117 guide member

131 spline shaft (second rotary shaft)

132 through-hole

133,134 support member

138 geared hollow shaft

139 pinion gear

140 drive gear

141 torque limiter (overload protection device)

142 torque sensor (overload protection device)

143 screw shaft

144 third drive device

151 control device

152 production control device

153 operation device

161 second rotary shaft

163 pinion gear

171, 172 driving force transmission system

S corrugated cardboard box (sheet)

B corrugated box

1. A slotter head comprising:
a fixed slotter knife base that has a disk shape and is rotatably supported;
a first cutting blade that is mounted on an outer peripheral portion of the fixed slotter knife base;
a moving slotter knife base that is movably supported by the fixed slotter knife base in a circumferential direction;
a second cutting blade that is mounted on an outer peripheral portion of the moving slotter knife base;
a first drive device that rotationally drives the fixed slotter knife base;
a second drive device that rotationally drives the moving slotter knife base; and
a control device that drives and controls the first drive device and the second drive device,
wherein the control device adjusts a relative rotation speed between the fixed slotter knife base and the moving slotter knife base at a start of rotation of the fixed slotter knife base and the moving slotter knife base, so that relative positions of the first cutting blade and the second cutting blade in a circumferential direction are adjusted.

2. The slotter head according to claim 1,
wherein a first rotary shaft is fixed to a center of the fixed slotter knife base, the moving slotter knife base is rotatably supported concentrically with the fixed slotter knife base, an internal gear is provided on an inner peripheral portion of the moving slotter knife base, an external gear of a second rotary shaft meshes with the internal gear, the first drive device is configured to rotate the first rotary shaft, and the second drive device is configured to rotate the second rotary shaft.

3. The slotter head according to claim 2,
wherein the second rotary shaft is disposed in parallel adjacent to the first rotary shaft and penetrates the fixed slotter knife base, and each end portion thereof in an axial direction is rotatably supported by a support member of the first rotary shaft.

4. The slotter head according to claim 2,
wherein a driven gear is fixed to an end portion of the second rotary shaft in an axial direction, a geared hollow shaft is rotatably supported concentrically with the first rotary shaft, a drive gear provided on an inner peripheral portion of the geared hollow shaft meshes with the driven gear, and the second drive device is configured to rotate the geared hollow shaft.

5. The slotter head according to claim 1,
wherein a first rotary shaft is fixed to a center of the fixed slotter knife base, the moving slotter knife base is rotatably supported concentrically with the fixed slotter knife base, an external gear is provided on an outer peripheral portion of the moving slotter knife base, an external gear of a second rotary shaft meshes with the external gear, the first drive device is configured to rotate the first rotary shaft, and the second drive device is configured to rotate the second rotary shaft.

6. The slotter head according to claim 1, further comprising an overload protection device that is provided in a driving force transmission system that transmits a driving force of the second drive device to the moving slotter knife base.

7. (canceled)

8. The slotter head according to claim 1,
wherein the control device adjusts a relative rotation speed between the fixed slotter knife base and the moving slotter knife base when controlling the fixed slotter knife base and the moving slotter knife base at the same constant rotation speed, so that relative positions of the first cutting blade and the second cutting blade in a circumferential direction are adjusted.

9. The slotter head according to claim 1,
wherein the control device adjusts a relative rotation speed between the fixed slotter knife base and the moving slotter knife base when rotation of the fixed slotter knife base and the moving slotter knife base is stopped, so that relative positions of the first cutting blade and the second cutting blade in a circumferential direction are adjusted.

10. The slotter head according to claim 1,
wherein the second cutting blade has an slotter knife blade having an arc shape and a tip provided at an end portion of the slotter knife blade in a circumferential direction, and
the control device adjusts a rotation speed of the moving slotter knife , so that at least a rotation speed when the tip separates from a sheet is lower than a rotation speed when the slotter knife blade comes into contact with the sheet.

11. The slotter head according to claim 1,
wherein the control device drives and controls the first drive device and the second drive device based on relative position information of the first cutting blade and the second cutting blade in the circumferential direction input from a production control device.

12. The slotter head according to claim 1,
wherein the control device drives and controls the first drive device and the second drive device based on relative position information of the first cutting blade and the second cutting blade in the circumferential direction input from an operation device operated by an operator.

13. A slotter device comprising:
an upper rotary shaft and a lower rotary shaft that are rotatably supported; and
an upper slotter head and a lower slotter head that are fixed to the upper rotary shaft and the lower rotary shaft, respectively to perform a groove cutting process of a sheet,
wherein the slotter head according to claim 1 is applied as the upper slotter head.

14. A box making machine comprising:
a sheet feeding section that supplies a sheet;
a printing section that performs printing on the sheet;
a slotter creaser section that has the slotter device according to claim 13, which performs a creasing line process and a groove cutting process on a surface of the sheet;
a folding section that forms a box body by folding the sheet and joining end portions; and
a counter-ejector section that discharges every predetermined number of the box bodies after stacking the box bodies while counting the box bodies.
